(19) United States
(12) Patent Application Publication
(10) Pub. No.: US 2004/0127232 A1
(43) Pub. Date: Jul. 1, 2004

(54) Method of tracking mobile station location

(76) Inventor: Michael Kotzin, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 10/334,281

(22) Filed: Dec. 31, 2002

(51) Int. Cl. H04Q 7/20

(52) U.S. Cl. 455/456.6; 455/432.1

(57) ABSTRACT

A method in a wireless communication device for tracking the location of the device using cookie files. The location of the device is determined by the device itself or the infrastructure in communication with the device. The location cookie files are created by or transmitted to the device by the communication system and can be interrogated or queried immediately by the device, the infrastructure, or stored for later use by both. When a location cookie, or a cookie associated with a location has been stored on the device, it can be queried to determine when the device has moved to or close to the same location as stored in the location cookie. The location in the cookie can also be used to guide the device to a certain location of the location cookie. The location cookie can also be used to track the number of time the device enters a certain location.

### BACKGROUND OF THE INVENTION

This invention relates to the use of location information regarding a portable wireless communication device and more particularly to a method of tracking the location of a device.

Wireless communication devices and more particularly portable handheld wireless communication devices are required by the United States Federal Communications Commission (FCC) to be locatable within 100 meters 67% of the time for network based solutions and within 50 meters 67% of the time for handset based solutions. The location determination of the device should be nearly instantaneous and continuous. The purpose for this information is primarily for the public safety system and provides dispatchers with the best location information relating to the mobile station. The communication system sends the mobile unit's location information to the 911 dispatcher and the dispatcher can accurately dispatch emergency services to the location. In this case however, the location information is only sent to the emergency dispatch service in a real time fashion. The device does not store or further utilize the device location information.

Data cookies generally are used in conjunction with the PC and the internet, allowing web page providers, mostly merchants, to track information regarding the user or more accurately the PC as it is used to access information on the internet via a browser. In this case the location of the PC is irrelevant, the PC can access the web site and the web site can store cookies on the PC regardless of the PC's location. In general the location of the PC cannot be determined.

As wireless devices become more and more ubiquitous the location and location habits of the user can reveal vital information to improve the functionality of the device and provide value to the device user. Also, as the internet becomes more and more wireless ready, there is a need for a method of tracking a device location.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

FIG. 1 is an exemplary view of a mobile station and a location cookie;

FIG. 2 is exemplary block diagram of the mobile station circuitry;

FIG. 3 is an exemplary view of a mobile station and a location cookie in an embodiment of the invention;

FIG. 4 is an exemplary view of a mobile station and a location cookie in an embodiment of the invention; and

FIG. 5 shows an exemplary mobile station according to an embodiment of the present invention.

### DETAILED DESCRIPTION OF THE PREFERRED EMBODIMENTS

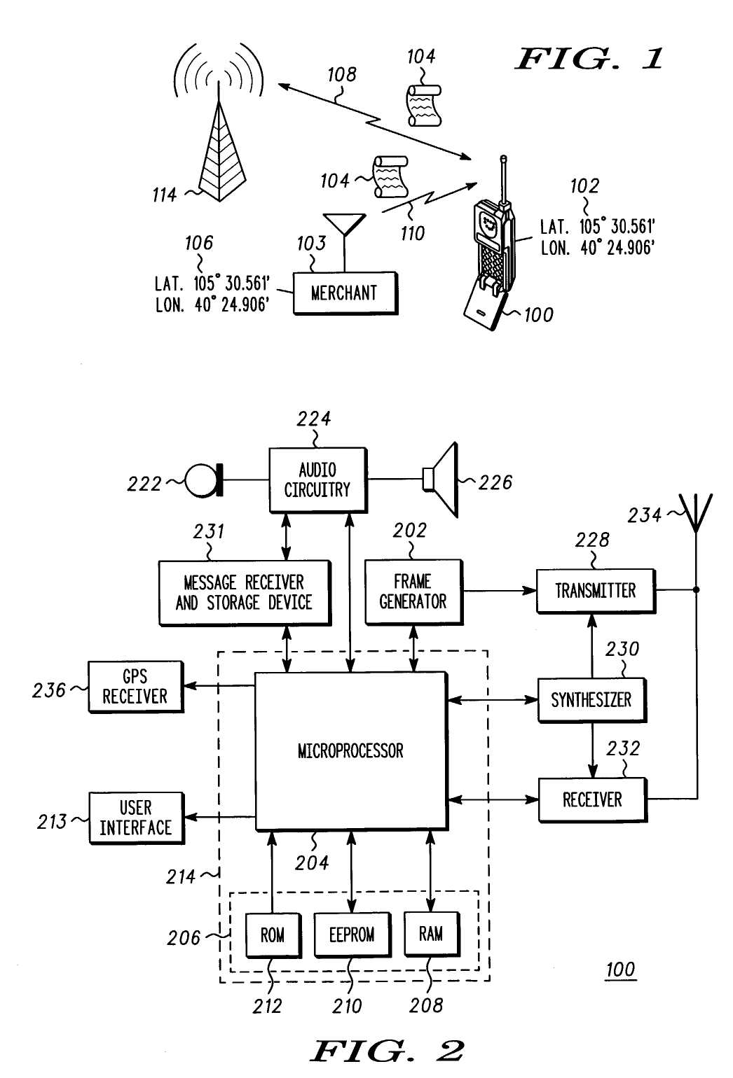

In FIG. 1, a wireless communication device or mobile station (MS) is illustrated in accordance with the present invention. The MS 100 is at a location 102 and in a first exemplary embodiment, receives a cookie file 104 or data cookie over a radio frequency (RF) link at location 102. The cookie 104 does not however need to be transmitted to the MS 100 when the MS 100 is at the same location as the entity generating the cookie data. The location of the MS 100 is known to the MS 100 or the communication system, or base station 114 (BS), or the merchant 103 having a location 106, which is the same or substantially the same as the MS location 102. The location of the MS 100 may also be within a predetermined range from the merchant 103 in order for the cookie file 104 to be received or queried by the MS 100. The cookie file 104 may be transmitted from the base station 114 over communication link 108, or over a local area network communication signal 110 located at the merchant 103.

A cookie is generally information, stored as text in a file, which is transmitted from a web server to the memory of a computer or device with a computer. The web server or any entity choosing to obtain the information therein can retrieve this information later. The information in the cookie file can be a simple time stamp indicating when the web browser downloaded certain information, or it may contain detailed information concerning the expiration date of the cookie file, a path or directory, a unique ID for the individual browser or user. The cookie file in the present invention, advantageously incorporates or is associated with a location, either the location of some desired entity, or the location of the mobile station itself or both.

In FIG. 2 a block diagram illustrates the wireless communication device or mobile station (MS) in accordance with the present invention. This MS 100 is a wireless communication device such as a cellular radiotelephone, a messaging device, a wireless gaming device, wireless PDA or the like, incorporating the present invention. The MS 100 has a frame generator ASIC 202, such as a CMOS ASIC available from Motorola, Inc. and a microprocessor 204, such as a 68HC11 microprocessor also available from Motorola, Inc., which combine to generate the necessary communication protocol for operating in the MS 100. Microprocessor 204 uses memory 206 comprising RAM 208, EEPROM 210, and ROM 212, preferably consolidated in one package 214, to execute the steps necessary to generate the protocol and to perform other functions of the MS 100, such as reading or writing to a user interface 213 (display, keyboard, keypad, mouse etc.) or controlling a frequency synthesizer 230 and other radio functions, running applications such as a browser and as a part of the browser program, controlling management of data files or cookie files received by the MS 100 through the receiver 232 in accordance with the present invention. An application specific integrated circuit (ASIC) 202 processes audio transformed by audio circuitry 224 from a microphone 222 and to a speaker 226. The consolidated memory package 214 is where the data or cookie files 104 are stored as the information is transferred from the source, over-the-air, and later retrieved from memory 206 to display on the device's display, or transmit information back to the base station upon request if desired. The location of the MS 100 can be determined by a GPS receiver 236 in the MS 100 (also coupled to the microprocessor 204) or from information sent by the base station 114. The microprocessor 204 can then combine the location information with the cookie file 104 stored in the memory 206 of the MS 100 in accordance with the present invention.

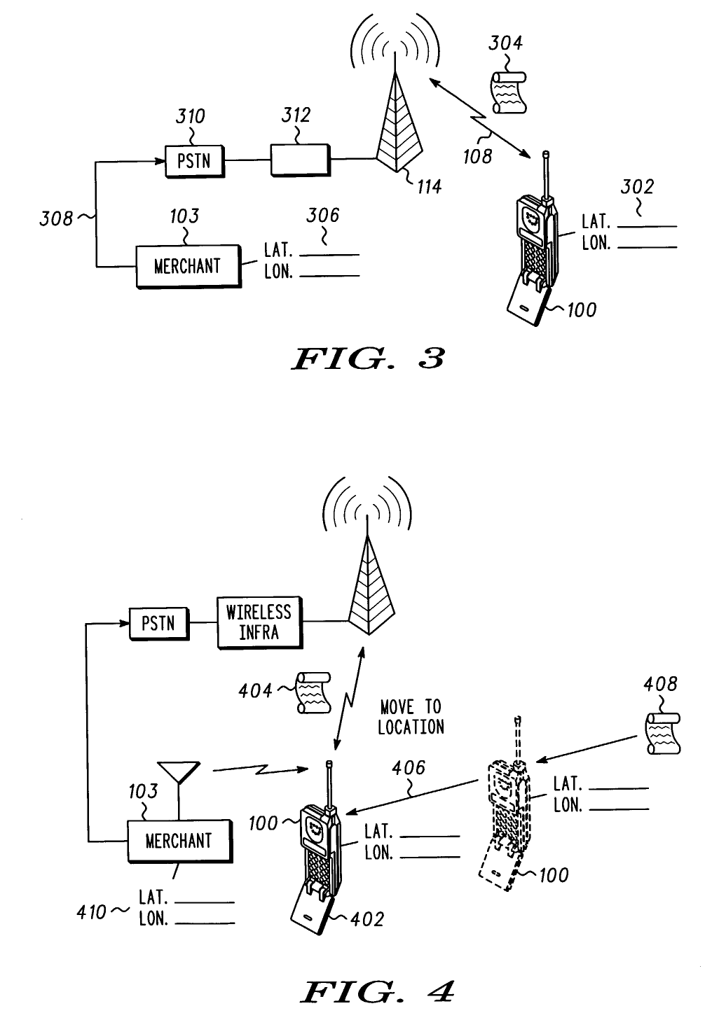

Placing cookies on a wireless device via a web browser for example, is in some ways analogous to the cookies placed or stored on a personal computer. However the MS 100 changes location on a regular basis, whereas the PC does not, or its location is irrelevant or not known. In an exemplary embodiment illustrated in FIG. 3 of the present invention, a cookie file 304 is stored on the MS 100 in two general circumstances: first, when the MS 100 is transacting with the merchant 103 wirelessly or second, when the MS 100 moves to a position in proximity to the merchant 103.

FIG. 3 illustrates the first case by showing for example; that the MS 100 has executed a transaction or an event has occurred with a merchant 103. The transaction does not have to occur with a merchant but can be any source wishing to place a cookie or control the placement of information on the MS 100. This is accomplished with the MS 100 by either making a purchase using the MS 100 or simply wirelessly browsing the merchants web page on the MS 100. The merchant 103 will generate a cookie file 304 as a result of either of these events or transactions and transmit the cookie file 304 to the MS 100. In this case the user does not have to be in close proximity to the merchant location 306. The cookie file 304 may be transmitted from the merchant 103, over a telephone line 308, (or some other connection) through the Public Telephone Switching Network (PSTN) 310 and to the wireless communication infrastructure system 312 and then to the MS 100 from the BS 114. The cookie file 304 in this exemplary embodiment is a location cookie, comprising the fixed location of the merchant 103 and other information as well regarding the merchant 103.

In one exemplary embodiment, the fixed location information in the cookie file 304 would be compared to the location of the MS 100 on a regular basis as the MS 100 moves about geographically. Once the location of the MS 100 approximately matches the fixed location in the cookie file 304, an event can be triggered. Location information does not necessarily need to be in the cookie file 304 as the presence of a certain cookie file 304 alone which is created by the merchant 103 would indicate that the MS 100 has been in merchant location 306.

The cookie file 304 sent from the merchant 103 may include for example the items purchased in previous visits to the actual store or the merchant website, the time of the purchases, the frequency that each individual item has been purchased or statistical or factual information that the merchant would use in relation to the user of the MS 100. If a merchant has multiple locations, such as McDonalds restaurants for example, the fixed location information for each location visited by the MS 100 would be stored in the cookie file 304. This cookie could be used to track which fixed locations, McDonalds locations, this user frequents the most, and may send the user a coupon for or directions to the nearest McDonalds. This would occur either when the MS 100 is within a given proximity or at a certain time of day such as lunch or dinnertime for example. The coupon may also be sent at a time, based on the time stored in the cookie file, at which the user has purchased similar or equivalent items.

Another exemplary embodiment, involves surfing web pages through a browser on the MS 100. As with the PC, cookies are downloaded to the MS 100 along with fixed location information. In one example, the user may view web pages from a software game developer company. The cookie file 304 from the developer would include all the locations where its software is available, or at least within the MS 100 home or immediate area. The MS 100, on a regular frequency, would compare the location of the MS 100 to at least one fixed location information in the cookie file 304. If the MS 100 location matches or is within a predetermined range of one of the at least one fixed locations, an event will be triggered. For example, the device could alert the user that the software game inquired about is available at a nearby merchant. The cookie file 304 could also contain the location of the merchant, and direction or mapping software in the MS 100 could provide directions directly to the merchant 103. If the MS 100 does not move directly to the merchant location when the alert is sent, the merchant developer could offer incentives to the user the next time the MS 100 passes the merchant location. Each time the user enters the location of the merchant; the cookie file 304 would be updated to include this new information. The MS 100 constantly queries the cookies and compares the MS 100 location to the fixed locations in the cookie file 304.

In another exemplary embodiment, when the MS 100 location matches the fixed location information of at least one cookie file 304, the device may transmit a message. The message could be sent to the merchant who created the cookie file 304 or to another MS. The merchant could then keep track at its own database when the MS 100 has entered locations. The message could be the cookie file 304 itself, being sent back to the merchant or creator to read and interpret the information in the cookie.

This next example describes the triggering of the transmission of the cookie file when the device enters a specific location. This is illustrated in FIG. 4 where the MS 100 enters a location 402. Again, for example, the fixed location is the merchant 103. The determination by the MS 100, the BS 114, or a wireless network at the merchant 103, that the MS 100 is in the first location 402 triggers an event to occur based on the cookie file and the first location 402. For example, the MS 100 is moved to a first location 402, indicated by arrow 406, which is the merchant 103. Based on this first position 402 a cookie file 404 is sent to the MS 100. If, in one exemplary embodiment, the MS 100 has been to this first location 402 previously and an original cookie file 408 has already been stored on the MS 100, the new cookie file 404 would update, augment or replace the original cookie file 408. Since the first location 402 here is fixed (i.e. the merchant 103) the cookie file 404 may contain for example, in addition to the fixed location information 410, data such as time arrived at the location 410, transactions or events occurring at the fixed location 410 involving both the merchant 103 and the MS 100, the number of visits by the MS 100 to the fixed location or any combination thereof.

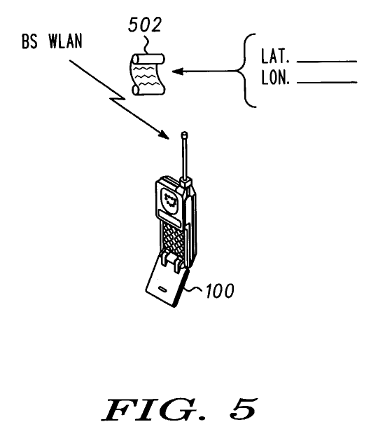

In one embodiment, illustrated in FIG. 5, a wireless local area network sends a cookie file 502 to the MS when the MS enters its network space. This could be a Bluetooth network, an ad hoc or a mesh network, a infrared protocol, WiFi or the like in which the network is tied to a specific location or area. In this case, the presence of the cookie file 502 indicates that the device has been in that location previously. The cookie file 404 would contain a time stamp indicating when the device was in that location as well as other identification information. When the MS 100 enters the location, the MS 100 is queried for any cookie file 502 created by that merchant. If a cookie file 502 is present on the MS 100, it is transmitted to the merchant. If not, as above, a new cookie file 502 is transmitted and stored on MS 100.

The cookie file 502 may also be sent over the communication network from the BS 114. In this case, the BS 114 would know the location of the device and also know the merchant location, for example the BS or infrastructure system would keep this information in its database 412. When the two locations approximately or substantially match the BS 114 would initiate the transfer of the cookie file 304. The merchant could subscribe to this service of the communication system. In both of the last two examples, location information does not need to be stored in the cookie file 502.

The cookie files can be managed on the MS 100 as with a PC. If the user desires to restrict certain cookie files, a filter can be used to screen incoming cookies. The user can also discard unwanted cookie files already on the device., or be informed when there is an attempt to store a cookie file on the MS 100. Cookie deletion may be time or location dependant. If a certain time is reached or the MS moves out of or into a predetermined location, the cookie would be deleted or altered to reflect the new time or location.

The location of the MS can be determined by several technologies. The communication system may employ the enhanced Observed Time Difference (E-OTD) method or the Uplink Time Difference of Arrival (U-TDOA) of determining location independent of the MS assistance. If the MS 100 is capable of full GPS reception or assisted GPS (aGPS), the MS can determine its location and communicate this through the communication system. Lastly the MS location can be determined by the presence in a WLAN. Each of these methods has their own accuracy associated therewith and the exact embodiment may require more accuracy or less. One of ordinary skill in the art would be able to determine the appropriate location determination method. In addition, it is realized that the location of the device will not exactly match the location in the cookie file and therefore as long as the locations approximately match or substantially match, this will be sufficient.

Although the invention has been described and illustrated with a certain degree of particularity, it is understood that the present disclosure of embodiments has been made by way of example only and that numerous changes in the arrangement and combination of parts as well as steps may be resorted to by those skilled in the art without departing from the spirit and scope of the invention as claimed.

What is claimed is:

1. A method in a wireless communication device:
determining a location of a wireless communication device;
receiving a cookie file by said wireless communication device at said location; and
associating said determined location to said cookie file.

2. The method of claim 1, determining said location of said wireless communication device by a global positioning system receiver coupled to said wireless communication device or by a communication system in communication with said wireless communication.

3. The method of claim 1, adding said determined location to said cookie file.

4. The method of claim 1, comparing continuously said determined location added to said cookie file with a location of said wireless communication device.

5. The method of claim 4, initiating an event in said wireless communication device when said determined location added to said cookie file is substantially the same as said location of said wireless communication device.

6. The method of claim 1,
receiving said cookie file through a communication system in communication with said wireless communication device or a wireless network.

7. The method of claim 1, transmitting said cookie file to a creator of said cookie file when said wireless communication device enters said location at a time later than when said cookie file was received.

8. A method in a wireless communication device comprising:
receiving a cookie file in a wireless communication device, said cookie file having location information;
activating a function of said wireless communication device upon determining said location information meets a criteria.

9. The method of claim 8, activating said function of said wireless communication device upon determining said location information of said cookie file is at least substantially equal to a location of the wireless communication device.

10. The method of claim 9, receiving a cookie file in said wireless communication device, said cookie file having a data set comprising fixed location information corresponding to a location of a creator of said data set in said cookie file.

11. The method of claim 10, receiving a cookie file in said wireless communication device, wherein said data set of said cookie file comprises information related to the web browsing of at least one web page of said creator of said cookie file, by a web browser of wireless communication device.

12. The method of claim 8, adding information to said cookie file each time the wireless communication device is positioned in a location or positioned within a range of locations corresponding to said location information in said cookie file.

13. The method of claim 11, adding information to said cookie file each time the wireless communication device is positioned in a location or positioned within a range of locations corresponding to said location information in said cookie file.

14. The method of claim 8, sending said cookie file to a requester when said wireless communication device is positioned in a location or positioned within a range of locations corresponding to said location information in said cookie file.

15. The method of claim 10, sending said cookie file back to said creator when said wireless communication device is positioned in a location or positioned within a range of locations corresponding to said location information in said cookie file.

16. The method of claim 8, said cookie file contains creator information, creator location, a time stamp, wireless communication device identification.

17. The method of claim 8, prior to the step of receiving said cookie file, transmitting device location information corresponding to the geographical location of the wireless communication device.

18. A method in a wireless communication device comprising:
receiving a location cookie file in the wireless communication device, said location cookie having fixed location data, representing a fixed location of the sender of the cookie file;
determining when a device location is substantially the same as said fixed location of said location cookie; and
activating a mode of the device when said device location is not substantially the same as said fixed location of said location cookie.

19. The method of Y, transmitting said cookie file to a creator of said cookie when said device location is not substantially the same as said fixed location of said location cookie.

20. A method of tracking location in a wireless communication device comprising:
receiving a cookie file at when the device is in a first position a first time;
receiving a request for said cookie file, when said device enters a position at a time later than said first time.

21. The method of claim 20, receiving a cookie file at when the device is in a first position a first time, said cookie file having location information.

22. The method of claim 21, wherein the location information is said first location.

23. The method of 20, determining that said device is in said first position at a time later than said first time, when said cookie file is present on the device at said later time.
